(19) United States
(12) Patent Application Publication
(10) Pub. No.: US 2012/0130963 A1
(43) Pub. Date: May 24, 2012

(54) USER DEFINED FUNCTION DATABASE PROCESSING

(75) Inventors: Congnan Luo, San Diego, CA (US); Guilian Wang, San Diego, CA (US); Yu Long, San Diego, CA (US); Phanibhushan Rao Pampati, San Diego, CA (US); Michael Leon Reed, San Diego, CA (US)

(73) Assignee: Teradata US, Inc., Miamisburg, OH (US)

(21) Appl. No.: 12/953,995

(22) Filed: Nov. 24, 2010

(51) Int. Cl. G06F 17/30

(52) U.S. Cl. 707/693; 707/737; 707/E17.032; 707/E17.046

(57) ABSTRACT

Apparatus, systems, and methods may operate to retrieve multiple rows of a database in response to receiving a request to execute an aggregate user defined function (UDF) over the multiple rows, to sort each of the multiple rows into common groups, grouping together individual ones of the multiple rows that share one of the common groups, and to send UDF execution requests to apply the aggregate UDF to aggregate buffers of the common groups to produce an aggregate result, so that one of the UDF execution requests and one context switch are used to process each of the aggregate buffers used within one of the groups to provide at least one intermediate result that can be processed to form the aggregate result. Other apparatus, systems, and methods are disclosed.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example code, screen shots, and images described below, and in any drawings appended hereto: Copyright 2010 Teradata, Inc. of Miamisburg, Ohio—All Rights Reserved.

### BACKGROUND

It is not uncommon to see the amount of data associated with a business venture grow at an exponential pace. To manage the increasing amount of data more efficiently, a database is often created. As the size of the database grows, so do the resources and time involved in processing the data, especially when the application of aggregate user defined functions (UDFs) is considered.

### BRIEF DESCRIPTION OF THE DRAWINGS

FIG. 1 illustrates how structured query language (SQL) statements can be adapted to improve the performance of aggregate UDF operations, according to various embodiments of the invention.

FIG. 2 is a flow diagram illustrating several methods of UDF database processing according to various embodiments of the invention.

FIG. 3 is a block diagram of apparatus and systems according to various embodiments of the invention.

FIG. 4 is a block diagram of an article of manufacture, including a specific machine, according to various embodiments of the invention.

### DETAILED DESCRIPTION

The application of UDFs to database processing has been supported by data warehousing software and service providers for several years. While UDFs are still written in the C programming language, Java has recently made great strides in popularity. Thus, it is recognized that a Java UDF might be used in some complex data analysis models.

To attract existing and potential customers that develop applications in Java on data warehousing systems, providers have begun to support UDFs written in Java. Examples of an execution environment that supports this type of operation include that provided by Teradata 13 database management software, available from Teradata, Inc. of Miamisburg, Ohio.

In some environments, a Java UDF runs only in a protected mode, as a separate process outside of the database. This is the case for two reasons.

First, it is infeasible to start a Java Virtual Machine (JVM) to execute Java code for each processor (e.g., an access module processor (AMP)) on a node, since there may be tens of processors per node. Thus, one protected mode Java UDF server is started per node (not per processor), and the JVM running within the server is used to handle all Java UDF execution requests from all processor threads running on that node.

Second, isolating Java UDF execution in a separate UDF server process, outside of the database, provides protection for the database server in the event the Java UDF has bugs, or consumes too much memory, or inordinate amounts of central processing unit (CPU) resources at runtime. Without isolation, abnormal Java UDF behavior can crash the database, or greatly slow operations, negatively affecting other concurrent users.

Protected operation is often accompanied by a performance penalty. Thus, the prospect of executing a Java Aggregate UDF often raises questions about the amount of degradation to be expected. By using the apparatus, systems, and methods described herein, the reduction in performance can often be dramatically reduced. An example of the potential for improvement will now be described.

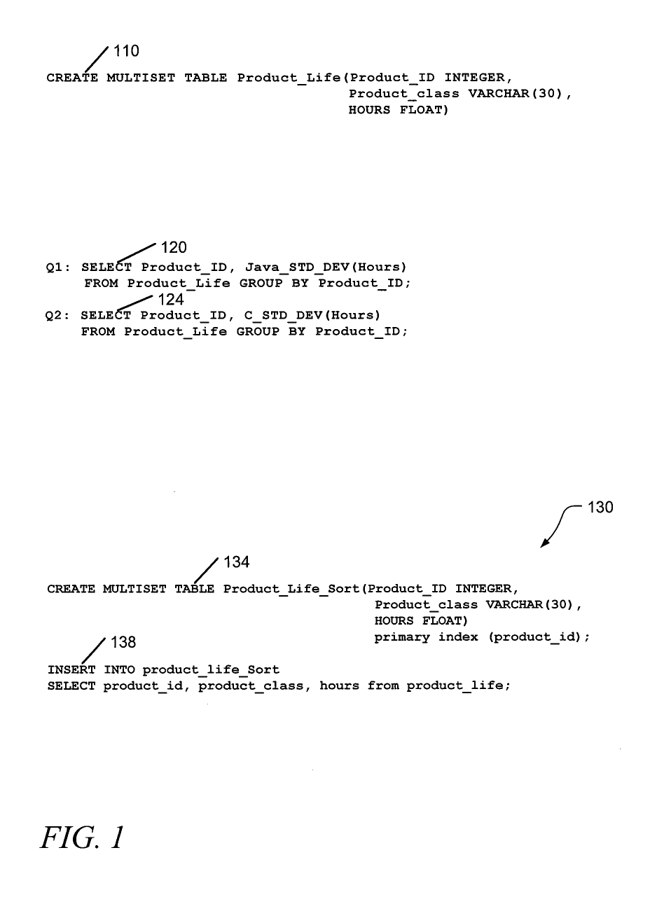

FIG. 1 illustrates how structured query language (SQL) statements can be adapted to improve the performance of aggregate UDF operations, according to various embodiments of the invention. For example, consider a manager employed by a light bulb manufacturer that uses a database with a table called Product_Life to determine the standard deviation of the lifetime for bulbs they sell to their customers. The table Product_Life is defined using the SQL CREATE statement 110.

The conventional queries used to make the determination of standard deviation may be expressed using the SQL SELECT statements 120, 124, depending on whether the UDF is written in Java or C, respectively. These queries are used to calculate the standard deviation of bulb lifetime in each group that has the same Product_ID (product identification number). It is noted that statement 120 uses a Java Aggregate UDF, Java_STD_DEV; statement 124 uses a protected mode C Aggregate UDF, C_STD_DEV.

To compare the results that are currently obtained with those that might be available if various embodiments are employed, the table Product_Life was filled with one million rows and fifty distinct Product_ID values, provide fifty groups. The number of rows in each group were approximately evenly distributed across each of the groups. Various embodiments were prototyped using simple SELECT statements, for both a Java Aggregate UDF and a protected mode C Aggregate UDF.

The elapsed time to process the Java Aggregate UDF was reduced from 206 seconds with the conventional approach, to 90 seconds using the novel approach described herein. This is less than one-half the prior processing time. Similar results were obtained using the novel approach for processing the protected mode C Aggregate UDF: reducing the time used from 34 seconds to 9 seconds, which is less than one-third of the prior processing time.

Generally, there are two major costs in the execution of a Java UDF: process switching costs, and Java startup/initialization costs. For every Java UDF call, protected mode logic performs a process switch. Thus, processing a million rows in a database means performing one million context switches. In addition, for every Java UDF call, the Java runtime environment is prepared: loading java classes, instantiating objects for these classes, and converting the input/output parameters between SQL data types and Java data types.

The inventors have determined that the total Java UDF execution cost over N rows is usually much higher than the cost of retrieving the same number of rows from disk and sorting them in a spool. The inventors have also determined that such costs might be reduced by packing multiple calls for the rows into the same group.

For example, consider the query:

SELECT department_id, Avg(age) FROM employee_tbl GROUP BY
department_id

Here the aggregate UDF Avg( ) is used to calculate the average age of all employees in each department. With conventional execution, each processor, such as an AMP, is assigned to operate on selected rows in the table, and directly retrieves these rows one by one. For each row, the processor copies the input data into a shared memory mapping file, sets up the calling stack, and then sends a request to the UDF server to execute the aggregate UDF for that input data. This conventional processing logic uses one CPU context switch between the AMP process and the UDF server process for each row. When the rows are retrieved from disk by the AMP, they could be in any order. For example, they might be retrieved in order of employee_id, but not department_id. When that occurs, the row input data can't be packed into the same group.

To implement various embodiments, the rows might be sorted on department_id for each AMP. Then, when the rows are retrieved, all rows in the same group will be presented together—as a group. At that time, the age values from rows in the same group can be packed into a buffer. When the buffer is full, the compacted input data can be copied into a shared memory mapping file, and a request can be sent to the UDF server once for processing all input data for multiple rows. This approach can result in drastically reducing the number of CPU context switches, because only one switch occurs for multiple rows. Even though this embodiment introduces the extra cost of retrieving and sorting rows in the spool, the overall processing time, on average, has been determined to be considerably less when compared to the conventional approach.

Startup costs add significantly to the execution of a Java Aggregate UDF (these same costs don't exist for the C UDF). Thus, even though process switch costs are common when executing both the protected mode C Aggregate UDF and the Java Aggregate UDF, context switch costs are the dominant cost for a protected mode C Aggregate UDF execution. Therefore, if the number of process switches are reduced during execution, both types of UDFs benefit. Extending this conclusion, the same approach should provide substantial improvement in database processing time, regardless of the language used.

In accordance with these principles, and to address some of the challenges described above, many embodiments operate to group rows together, where each group can be processed by a single Aggregate UDF request. Some of the implementation details used to realize various embodiments will now be discussed.

The logic for evaluating an Aggregate UDF in a query can be simplified by reading the rows from a source of data, which could be a base table or a spool table, built locally or redistributed from other AMPs. Each row read in can be passed to an intermediate spool, for example, and then the spool can be sorted on “Group By” columns. In this way, all the rows in the same group will be grouped together. The sorted spool can then be used to replace the original source for further processing.

The conventional use of pointers can also be simplified. Thus, an input data group buffer pointer can be created and passed to wherever it is needed, rather than making use of individual row pointers. The group buffer is used to save the inputs of multiple rows in the same group. If an individual input of a row can be put into the buffer (and it is not the last row in the current group), the logic simply returns without calling the aggregate UDF. Only when the buffer is filled, or the last row in the current group is encountered, is the aggregate UDF called via the UDF server.

An input is the value of a column (or values of multiple columns) in a row. The input value depends on the IN parameters of the aggregate UDF. For example, consider a table created as follows:

Employee_tbl( employee_id INTEGER,

| | |
|---|---|
| name | CHAR(50), |

| | |
|---|---|
| age | INGEGER, |
| salary | FLOAT, |
| department_id | INTEGER, |
| global_grade | CHAR(2)); |

And the associated query:

SELECT department_id, Avg(age) FROM Emplyee_tbl

GROUP BY department_id;

Because the aggregate UDF Avg( ) has only one parameter, the input data for a call to this aggregate UDF is only the value of the column age. Therefore, the values of age of multiple rows in the same group are buffered. Other columns in the row are not buffered. After the buffer is filled, or the last row is encountered, the buffer can be copied to a shared memory mapping file, which is used as a communication channel between a processor (e.g., an AMP) and the UDF server process.

Thus, if there are 100 rows in a group, 100 age values are buffered, and copied to the shared memory mapping file. As a result, there are 100 input data in the shared memory mapping file.

In addition, if multiple input data in a group comprise repeated values, the number of redundant operations can be reduced by using a frequency and value pair. This is done by compacting the input data.

For example, considering the 100 age values in the buffer, if 40 of them are for persons that are 35-years old, then the 40 values can be compacted into a frequency-value pair: (40, 35). Compaction saves space and increases efficiency; parameters are set in the stack for UDF call execution. For this example, the pair is set up one time, and the stack is used 40 times.

This approach can be useful when an Aggregate Java UDF is implemented, because instead of instantiating Java class objects from the input data for each call, these objects can be instantiated once for multiple repeated input data. In this way, the JVM can use the objects as the parameters to make one aggregate UDF call

Whether the repeated data is compacted or not, all inputs can be copied from a group buffer into the memory mapping file to be passed on to the UDF server. Thus, if a group buffer fills up (before the last row in a group is encountered), it is copied to the memory mapping file, after which the UDF execution request is made to initiate operation by the UDF server process on all the data in the memory mapping file. When complete, the same buffer is filled again with the remaining rows, and the process of copying and calling are repeated. The database maintains intermediate results in a cache to aggregate them. The group buffer size generally depends on memory size limitations.

Java classes can be selectively instantiated, as mentioned previously, rather than instantiated for each call, as occurs in the conventional logic. Thus, a Java Hybrid UDF server can receive the inputs from a memory mapping file, loading all needed Java classes and instantiating many, if not all, objects of these classes only once thereafter.

Finally, a loop can be used to iteratively process each input stored in the memory mapping file. All loaded classes, and many instantiated objects, can be reused across all inputs in the file. The UDF server instantiates the input objects for each input, and calls the Java Aggregate UDF repeatedly until all inputs are processed. The loop executes entirely within the UDF server, so that there are no process switches between the database system server processes and the UDF process. For protected mode C Aggregate UDF execution, the input from the memory mapping file is simply copied to the stack of the UDF, and then the UDF is repeatedly called for each input in the stack.

In one embodiment, rows are not retrieved from a database and sorted in a spool. Rather, the rows are sorted in an alternative manner. For example, the rows may be sorted on “Group By” columns in a temporary table before the Aggregate UDF for each row is evaluated. Then the original query is performed on the sorted source. Thus, the statements 130 are added to populate the rows from the original base table Product_Life to the temporary table Product_Life_Sort. The statement 134 creates the temporary table Product_Life_Sort and then statement 138 populates the rows from Product_Life to Product_Life_Sort. Since the temporary table Product_Life_Sort has a primary index on the value (Product_ID), the rows of the table Product_Life_Sort are placed in the order of (Product_ID) on the storage medium. Later, when the SELECT statement query is performed on this new source (i.e., the rows in the temporary table), the rows will be retrieved from storage in the desired order. An appropriate SQL SELECT statement might now read as:

SELECT Product_ID, Java_STD_DEV(hours) FROM
Product_Life_Sort

GROUP BY Product_ID;

This alternative implementation can take the place of sorting all rows into common groups to provide a sorted spool, before providing the sorted rows to the UDF server that executes an aggregate query. In this alternative implementation, all rows are selected from the original source table and then inserted into a temporary table, perhaps using a single SQL “INSERT INTO . . . SELECT” statement. The Primary Index of the temporary table is defined on the column that was used in the grouping clause (e.g., using the SQL GROUP BY statement) of the aggregate query. This results in physically storing the temporary table rows (e.g., on disk) in the order of the Primary Index, i.e. according to the column specified in the SQL GROUP BY statement.

It is noted that the “INSERT INTO . . . SELECT” statement is a single SQL statement that contains two activities. The first activity is retrieving rows from a source table, and the second activity is inserting these rows into a target table. The two activities are contained in the one unit of work for this statement.

Thus, when the rows are retrieved, one by one from the temporary table, and the aggregate UDF is executed for each row that is retrieved, the rows in the same group will be presented together—as a group. This permits packing the input data from multiple rows in the same group and sending the packed input data to the UDF server once—for all of the packed data in the same group.

Sorting all rows into common groups to provide a sorted spool may be useful in many cases, since this process can often be accomplished internally—as part of executing the aggregate UDF query. The alternative implementation does not afford this benefit. Rather, the more expensive alternative approach, in terms of resources and time expended, makes use of two externally-visible SQL statements 134, 138, as shown in the figure.

During operational tests, using the table configuration discussed previously, the set of SQL statements 130 results in a total elapsed time (for the optimized Java Aggregate UDF queries) of 90 seconds, which included 6 seconds for the “CREATE TABLE” and “INSERT INTO” statements, and another 84 seconds for the “SELECT” statement.

It should be noted that the “INSERT INTO . . . SELECT” statements operate to retrieve rows from the source table, redistribute the rows by a hash coding of the Product_ID value, sort the spool by row hash value, and then merge rows from the spool into the base table Product_life_Sort. This alternative approach is believed to be more expensive in terms of resource and time use than the internalized approach of retrieving rows into an intermediate spool, which is then sorted before calling the aggregate UDF. Therefore, it is expected that the true overall performance improvement for the latter approach, whether a Java Aggregate UDF or protected mode C Aggregate UDF are applied, will be even better than what has been noted herein.

In summary, in many embodiments, in response to receiving a request to execute an aggregated UDF, multiple rows are retrieved and sorted into groups. Then a series of UDF execution requests are sent to the UDF server, with one request and one context switch per aggregate buffer processed within a group. If memory size permits, only one buffer is used per group.

Thus, many embodiments of the invention may be realized, and each can be implemented in a variety of architectural platforms, along with various operating and server systems, devices, and applications. Any particular architectural layout or implementation presented herein is therefore provided for purposes of illustration and comprehension only, and is not intended to limit the various embodiments.

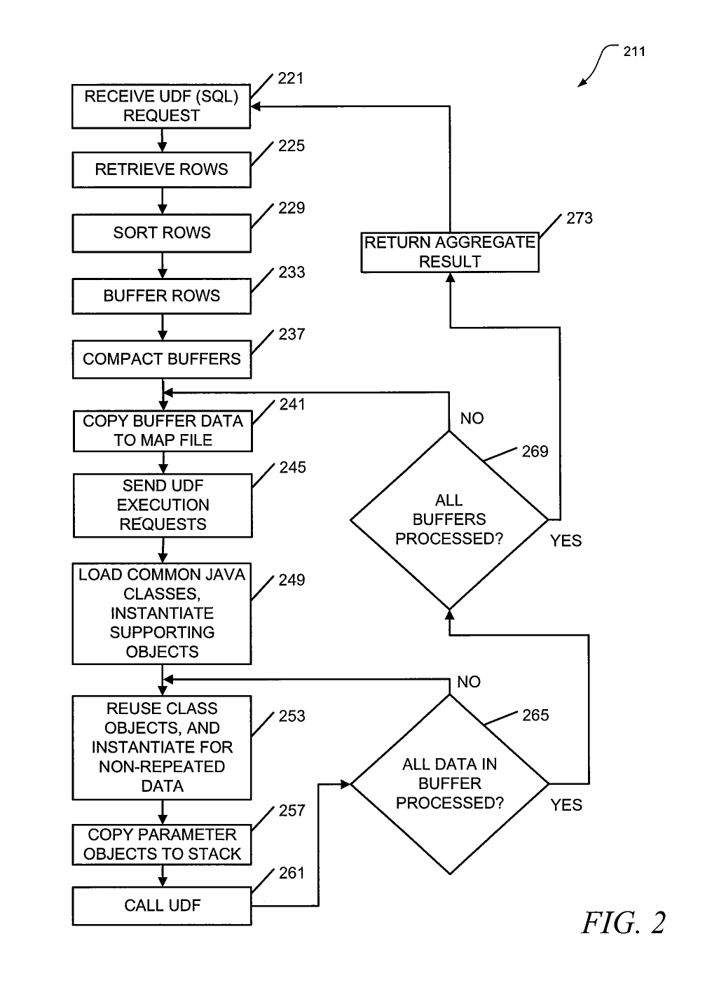

FIG. 2 is a flow diagram illustrating several methods 211 of UDF database processing according to various embodiments of the invention. The methods 211 are implemented in a machine-accessible and readable medium, and are operational over processes within and among networks. The networks may be wired, wireless, or a combination of wired and wireless. The methods 211 may be implemented as instructions, which when accessed by a specific machine, perform the processing depicted in FIG. 2.

In some embodiments, the method 211 may comprise a processor-implemented method to execute on one or more processors that perform the method. The method 211 may begin at block 221 with receiving a request, which may be expressed as a SQL statement, to execute an aggregate UDF over the multiple rows. That is, the aggregate UDF request may be received as a SQL statement request, including a single SQL request. In some embodiments, the request may comprise a request to execute a Java aggregate UDF over the multiple rows.

The method 211 may continue on to block 225 with retrieving multiple rows of a database in response to receiving the request of block 221.

The original data can be retrieved from a base table or a spool table, as well as from other table types. Thus, the activity at block 225 may comprise retrieving multiple rows of the database from a base table or a spool table, among others.

The method 211 may continue on to block 229 with sorting each of the multiple rows into common groups, to group together individual ones of the multiple rows that share one of the common groups.

Sorting may be conducted along one or more columns. Thus, in some embodiments, the GROUP BY clause is used in a SQL SELECT statement to collect data across multiple records and group the results by one or more columns. Therefore, the activity at block 229 may comprise sorting each of the multiple rows on one or more columns listed in a GROUP BY clause.

The rows can be further sorted in a variety of ways. For example, the activity at block 229 may comprise selecting all of the multiple rows from the database comprising an original source table, and inserting all of the multiple rows into a temporary table having a primary index to order the multiple rows into a desired sort order.

As noted previously, the activity of sorting may be accomplishing using SQL statements. Thus, the activity at block 229 might further include selecting all of the multiple rows and inserting these rows into the temporary table by using a single INSERT INTO . . . SELECT SQL statement.

An aggregate buffer is formed by buffering the rows in a group, until the buffer is full. If sufficient memory is provided, only one buffer is used for an entire group of rows. Thus, the method 211 may continue on to block 233 with buffering member rows of the common groups to fill the aggregate buffers.

Compacting data by substituting pairs for repeated values can be used to reduce redundancy, increasing processing efficiency. Thus, the method 211 may continue on to block 237 with compacting individual ones of the aggregate buffers by replacing repeated input data from individual ones of the common groups with a frequency and common value pair.

A memory mapping file can be used as a common communication conduit. Thus, the method 211 may comprise, at block 241, copying input data from one of the aggregate buffers into a shared memory mapping file.

The method 211 may continue on to block 245 with sending UDF execution requests to apply the aggregate UDF to aggregate buffers of the common groups to produce an aggregate result, so that one of the UDF execution requests and one context switch are used to process each of the aggregate buffers used within one of the groups to provide at least one intermediate result that can be processed to form the aggregate result.

In some embodiments, Java UDF execution requests are used. Thus, the activity at block 245 may comprise sending Java UDF execution requests to apply a Java aggregate UDF to aggregate buffers of the common groups to produce an aggregate result, so that one of the Java UDF execution requests and one context switch are used to process each of the aggregate buffers used within one of the groups to provide at least one intermediate result that can be processed to form the aggregate result.

A UDF processor, perhaps in the form of a server, can be used to receive the requests to apply the requested UDF to the buffered rows. Thus, the activity at block 245 may comprise sending the UDF execution requests to a UDF processor.

The UDF execution requests can be applied to the memory mapping file. Thus, the activity at block 245 may comprise sending one of the UDF execution requests to execute the aggregate UDF for all the input data in the shared memory mapping file, and updating one or more intermediate results as part of forming the aggregate result.

As noted previously, when Java UDF execution requests are made, the effects of reduced class loading and object instantiation should be considered. Thus, when a JVM starts to execute a Java UDF, it is recognized that commonly used classes are loaded, and Java objects of these classes are instantiated to support the Java runtime environment. These classes/objects can be loaded/instantiated once for processing all input data in the buffer.

In addition, each time the Java UDF is invoked for specific input data in the buffer, corresponding specific Java objects are instantiated for that specific input data, so that the JVM can use these specific objects as pass-in parameters to feed into the Java UDF, and then the Java UDF can use them in its calculations. These objects are known by those of ordinary skill in the art as “parameter Java class objects”.

As noted previously, repeated input data can be compacted into frequency-value pairs. Thus, the number of times input data are repeated is known. Java class objects can be instantiated for all repeated input data once, and then reused as pass-in parameters to invoke the Java UDF for the remainder of the repeated input data. In this way, Java classes can be loaded once for reuse, and Java class objects can be reused for individual rows in the aggregate buffers that have repeating data.

As a result, the method 211 may continue on to block 249 to include loading commonly used supporting Java classes and instantiating supporting objects of the supporting Java classes once in response to receiving one of the Java UDF execution requests. The method 211 may continue on to block 253 to include reusing previously instantiated parameter Java class objects for repeated input data in the aggregate buffers, as well as instantiating new parameter Java class objects to process non-repeated input data in the aggregate buffers.

The method 211 may continue on to block 257, where the instantiated parameter Java class objects are copied to a stack in the Java UDF processor (prior to calling the Java aggregate UDF). The parameter Java class objects on the stack are instantiated in block 253. They might be reused objects if the parameter data passed into the UDF are repeated. The parameter Java class objects placed on the stack at block 257 are different from the supporting Java class objects instantiated in block 249. Thus, the activity at block 257 may comprise copying the parameter Java class objects to a Java UDF stack in a UDF processor.

At this point, the inputs in the memory map file, and/or the parameter Java class objects, are ready for processing. Thus, the method 211 may include, at block 261, calling the UDF for execution.

If all of the data in the buffer has not yet been processed, as determined at block 265, the method 211 may include returning to block 253. If all of the data in the buffer has been processed, as determined at block 265, the method 211 may go on to include block 269, where a determination is made with respect to processing all of the buffers.

If all of the buffers are not yet processed, as determined at block 269, the method 211 may include returning to block 241, to copy additional buffer data to the map file. If all of the buffers have been processed, as determined at block 269, the method 211 may go on to include block 273.

At block 273, the aggregate result for each group in a row can be returned. There will be one and only one aggregate result for each group. That is, if there are N groups, there will be N aggregate results and thus N resultant rows. For example, if a table has ten rows divided among three groups in total (e.g., two rows in group 1, three rows in group 2, and five rows in group 3), the aggregate SQL request will return three resultant rows, with each resultant row containing a final aggregate result for all the rows in that one group. Thus, the activity at block 273 may comprise returning the aggregate result for each of the common groups in a resultant row.

The methods described herein do not have to be executed in the order described, or in any particular order. Moreover, various activities described with respect to the methods identified herein can be executed in repetitive, serial, or parallel fashion. The individual activities of the methods shown in FIG. 2 can also be combined with each other and/or substituted, one for another, in various ways. Information, including parameters, commands, operands, and other data, can be sent and received in the form of one or more carrier waves. Thus, many other embodiments may be realized.

The methods shown in FIG. 2 can be implemented in various devices, as well as in a computer-readable storage medium, where the methods are adapted to be executed by one or more processors. Further details of such embodiments will now be described.

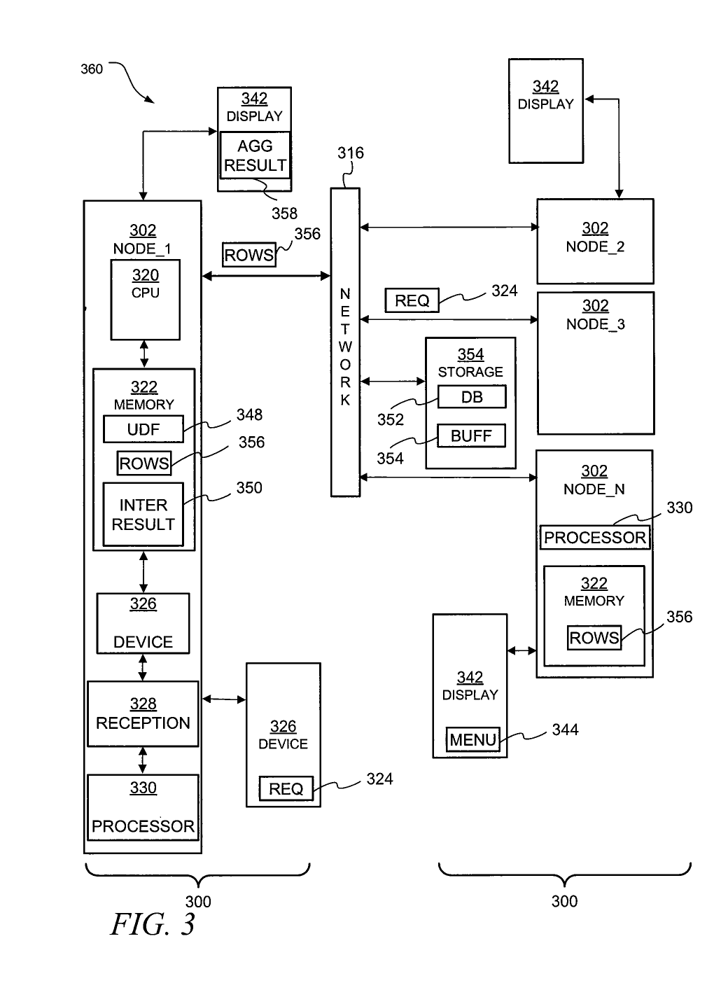

FIG. 3 is a block diagram of apparatus 300 and systems 360 according to various embodiments of the invention. Here it can be seen that an apparatus 300 used to implement improved UDF database processing may comprise one or more processing nodes 302, one or more processors 320, memories 322, one or more user input devices 326, a data reception module 328, a processor module 330, and one or more displays 342. The apparatus 300 may comprise a client, a server, or a networked processing node.

The processing nodes 302 may in turn comprise physical machines or virtual machines, or a mixture of both. The nodes 302 may also comprise networked entities, such servers and/or clients. In some cases, the operations described herein can occur entirely within a single node 302. In some embodiments then, an apparatus 300 may comprise a data reception module 328 to receive a request 324 for the application of an aggregate UDF 348 to a database 352, and a processor 330 to apply the aggregate UDF 348 across sorted groups.

In some embodiments, an apparatus 300 may comprise a reception module 328 to retrieve multiple rows 356 of a database 352 in response to receiving a request 324 to execute an aggregate UDF 348 over multiple rows 356. The apparatus 300 may further comprise a processor 330 to sort each of the multiple rows 356 into common groups. The processor 330 may further operate to group together individual ones of the multiple rows 356 that share one of the common groups, and to send UDF execution requests to apply the aggregate UDF 348 to aggregate buffers 354 of the common groups to produce an aggregate result 358, so that one of the UDF execution requests and one context switch are used to process each of the aggregate buffers 354 used within one of the groups to provide at least one intermediate result 350 which can be processed to form the aggregate result 358.

The result of executing the aggregate UDF 348 may be presented to the user on a display. Thus, the apparatus 300 may further comprise a display 342 to receive publication of at least a portion of the aggregate result 358.

The data stored in the database 352, to which the aggregate UDF 348 is applied, may be processed using multiple AMPs, and remote storage nodes. Thus, the apparatus 300 may further comprise multiple database processors 330 (e.g., AMPs) coupled to corresponding storage nodes 302, 354 that each include some of the multiple rows 356 that form a portion of the database 352. In some embodiments, the apparatus 300 comprises a storage node 354 that includes a storage medium.

Operations can be divided up into multiple nodes. Thus, the apparatus 300 may comprise a first node 302 (e.g., NODE_1) to house the reception module 328 comprising a request dispatcher. The apparatus 300 may further comprise a second node (e.g., NODE_N) to house the processor 330 comprising one or more AMPs.

A client machine can be used to formulate and transmit the request. Thus, the apparatus 300 may comprise a user input device 326 comprising a client machine to transmit the request 324.

Still further embodiments may be realized. For example, it can be seen that a system 360 that operates to implement improved UDF database processing may comprise multiple instances of the apparatus 300. The system 360 might also comprise a cluster of nodes 302, including physical and virtual nodes. It should be noted that any of the nodes 302 may include any one or more of the elements explicitly shown in nodes NODE_1, NODE_2, NODE_3, . . . NODE_N, and one or more storage nodes 354.

The apparatus 300 and systems 360 may be implemented in a machine-accessible and readable medium that is operational over one or more networks 316. The networks 316 may be wired, wireless, or a combination of wired and wireless. The apparatus 300 and system 360 can be used to implement, among other things, the processing associated with the methods 211 of FIG. 2. Modules may comprise hardware, software, and firmware, or any combination of these. Additional embodiments may be realized.

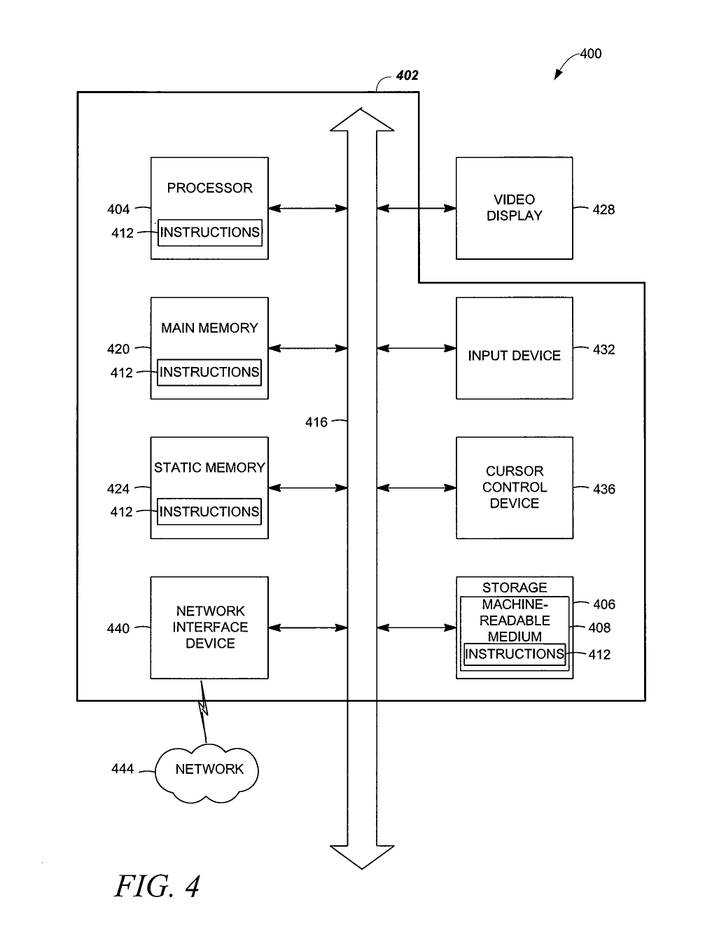

For example, FIG. 4 is a block diagram of an article 400 of manufacture, including a specific machine 402, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-oriented format using an object-oriented language such as Java or C++. Alternatively, the programs can be structured in a procedure-oriented format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 400 of manufacture, such as a computer, a memory system, a magnetic or optical disk, some other storage device, and/or any type of electronic device or system may include one or more processors 404 coupled to a machine-readable medium 408 such as a memory (e.g., removable storage media, as well as any memory including an electrical, optical, or electromagnetic conductor) having instructions 412 stored thereon (e.g., computer program instructions), which when executed by the one or more processors 404 result in the machine 402 performing any of the actions described with respect to the methods above.

The machine 402 may take the form of a specific computer system having a processor 404 coupled to a number of components directly, and/or using a bus 416. Thus, the machine 402 may be similar to or identical to the apparatus 300 or system 360 shown in FIG. 3.

Turning now to FIG. 4, it can be seen that the components of the machine 402 may include main memory 420, static or non-volatile memory 424, and mass storage 406. Other components coupled to the processor 404 may include an input device 432, such as a keyboard, or a cursor control device 436, such as a mouse. An output device 428, such as a video display, may be located apart from the machine 402 (as shown), or made as an integral part of the machine 402.

A network interface device 440 to couple the processor 404 and other components to a network 444 may also be coupled to the bus 416. The instructions 412 may be transmitted or received over the network 444 via the network interface device 440 utilizing any one of a number of well-known transfer protocols (e.g., HyperText Transfer Protocol). Any of these elements coupled to the bus 416 may be absent, present singly, or present in plural numbers, depending on the specific embodiment to be realized.

The processor 404, the memories 420, 424, and the storage device 406 may each include instructions 412 which, when executed, cause the machine 402 to perform any one or more of the methods described herein. In some embodiments, the machine 402 operates as a standalone device or may be connected (e.g., networked) to other machines. In a networked environment, the machine 402 may operate in the capacity of a server or a client machine in server-client network environment, or as a peer machine in a peer-to-peer (or distributed) network environment.

The machine 402 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 402 is illustrated, the term “machine” shall also be taken to include any collection of machines that individually or jointly execute a set (or multiple sets) of instructions to perform any one or more of the methodologies discussed herein.

While the machine-readable medium 408 is shown as a single medium, the term “machine-readable medium” should be taken to include a single medium or multiple media (e.g., a centralized or distributed database, and/or associated caches and servers, and or a variety of storage media, such as the registers of the processor 404, memories 420, 424, and the storage device 406 that store the one or more sets of instructions 412). The term “machine-readable medium” shall also be taken to include any medium that is capable of storing, encoding or carrying a set of instructions for execution by the machine and that cause the machine 402 to perform any one or more of the methodologies of the present invention, or that is capable of storing, encoding or carrying data structures utilized by or associated with such a set of instructions. The terms “machine-readable medium” or “computer-readable medium” shall accordingly be taken to include non-transitory, tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to improve the execution speed of aggregate UDF database processing. Increased efficiency and customer satisfaction may result.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, comprising:
a reception module to retrieve multiple rows of a database in response to receiving a request to execute an aggregate user defined function (UDF) over the multiple rows; and
a processor to sort each of the multiple rows into common groups, to group together individual ones of the multiple rows that share one of the common groups, and to send UDF execution requests to apply the aggregate UDF to aggregate buffers of the common groups to produce an aggregate result, so that one of the UDF execution requests and one context switch are used to process each of the aggregate buffers used within one of the groups to provide at least one intermediate result that can be processed to form the aggregate result.

2. The apparatus of claim 1, further comprising:
a display to receive publication of at least a portion of the aggregate result.

3. The apparatus of claim 1, further comprising.
multiple database processors, including the processor, coupled to corresponding storage nodes that each include some of the multiple rows that form a portion of the database.

4. The apparatus of claim 1, further comprising:
a first node to house the reception module comprising a request dispatcher; and
a second node to house the processor comprising an access module processor.

5. The apparatus of claim 1, further comprising:
a user input device comprising a client machine to transmit the request.

6. A processor-implemented method to execute on one or more processors that perform the method, comprising:
retrieving multiple rows of a database in response to receiving a request to execute an aggregate user defined function (UDF) over the multiple rows;
sorting each of the multiple rows into common groups, to group together individual ones of the multiple rows that share one of the common groups; and
sending UDF execution requests to apply the aggregate UDF to aggregate buffers of the common groups to produce an aggregate result, so that one of the UDF execution requests and one context switch are used to process each of the aggregate buffers used within one of the groups to provide at least one intermediate result that can be processed to form the aggregate result.

7. The method of claim 6, wherein receiving the request comprises:
receiving a single structured query language (SQL) request.

8. The method of claim 6, wherein the sorting further comprises:
sorting each of the multiple rows on one or more columns listed in a GROUP BY clause.

9. The method of claim 6, further comprising:
buffering member rows of the common groups to fill the aggregate buffers.

10. The method of claim 6, wherein the sending further comprises:
sending the UDF execution requests to a UDF processor.

11. The method of claim 6, further comprising:
compacting individual ones of the aggregate buffers by replacing repeated input data from individual ones of the common groups with a frequency and common value pair.

12. The method of claim 6, further comprising:
copying input data from one of the aggregate buffers into a shared memory mapping file.

13. The method of claim 12, further comprising:
sending one of the UDF execution requests to execute the aggregate UDF for all the input data in the shared memory mapping file; and
updating the at least one intermediate result as part of the aggregate result.

14. The method of claim 6, further comprising:
returning the aggregate result for each of the common groups in a resultant row.

15. The method of claim 6, wherein the retrieving comprises:
retrieving multiple rows of the database from a base table or a spool table.

16. The method of claim 6, wherein the sorting comprises:
selecting all of the multiple rows from the database comprising an original source table; and
inserting all of the multiple rows into a temporary table having a primary index to order the multiple rows into a desired sort order.

17. The method of claim 16, wherein the selecting and the inserting are accomplished using a single INSERT INTO . . . SELECT SQL statement.

18. A processor-implemented method to execute on one or more processors that perform the method, comprising:
retrieving multiple rows of a database in response to receiving a request to execute a Java aggregate user defined function (UDF) over the multiple rows;
sorting each of the multiple rows into common groups, to group together individual ones of the multiple rows that share one of the common groups;
sending Java UDF execution requests to apply the Java aggregate UDF to aggregate buffers of the common groups to produce an aggregate result, so that one of the Java UDF execution requests and one context switch are used to process each of the aggregate buffers used within one of the groups to provide at least one intermediate result that can be processed to form the aggregate result.

19. The method of claim 18, further comprising:
loading commonly used supporting Java classes and instantiating supporting objects of the supporting Java classes once in response to receiving one of the Java UDF execution requests;
reusing previously instantiated parameter Java class objects for repeated input data in the aggregate buffers; and
instantiating new parameter Java class objects to process non-repeated input data in the aggregate buffers.

20. The method of claim 19, further comprising:
copying the parameter Java class objects to a Java UDF stack in a UDF processor.
